(19) United States
(12) Patent Application Publication
(10) Pub. No.: US 2025/0140481 A1
(43) Pub. Date: May 1, 2025

(54) CAPACITOR AND MANUFACTURING METHOD THEREOF

(71) Applicant: SAMSUNG ELECTRO-MECHANICS CO., LTD., Suwon-si (KR)

(72) Inventors: Moonchul Lee, Suwon-si (KR); Sung-Min Cho, Suwon-si (KR); Sehun Park, Suwon-si (KR); Taejoon Park, Suwon-si (KR); Seung-Hun Han, Suwon-si (KR); Jungmin Kim, Suwon-si (KR)

(73) Assignee: SAMSUNG ELECTRO-MECHANICS CO., LTD., Suwon-si (KR)

(21) Appl. No.: 18/414,235

(22) Filed: Jan. 16, 2024

(30) Foreign Application Priority Data
Oct. 27, 2023 (KR) 10-2023-0145382

(51) Int. Cl. H01G 4/30; H01G 4/008; H01G 4/012; H01G 4/12

(52) U.S. Cl. CPC H01G 4/30; H01G 4/008; H01G 4/012; H01G 4/12

(57) ABSTRACT

A capacitor according to one aspect includes: a substrate in which a groove having a first depth from an upper surface is formed; and a body including a first internal electrode and a second internal electrode stacked disposing a dielectric layer therebetween, and disposed on the groove, wherein a width of the groove may be 1 or more compared to the first depth of the groove and a length of the groove may be 1 time or more compared to the first depth of the groove.

### CROSS-REFERENCE TO RELATED APPLICATION

This application claims priority to and the benefit of Korean Patent Application No. 10-2023-0145382 filed in the Korean Intellectual Property Office on Oct. 27, 2023, the entire contents of which are incorporated herein by reference.

### TECHNICAL FIELD

The present disclosure relates to a capacitor and a manufacturing method thereof.

### BACKGROUND

Electron part used in electronic devices include a capacitor, an inductor, a piezoelectric element, a varistor, or a thermistor. Among these ceramic electron components, a stacked capacitor may be used in various electronic devices because it has a small size, guarantees high-capacity, and can be easily installed.

For example, the stacked capacitor is used in chip-type condenser that is mounted on a substrate of various electronic products such as image devices such as a liquid crystal display (LCD), a plasma display panel, an organic light-emitting diode (OLED), and the like, a computer, a personal portable terminal, a smartphone, and the like to serve to charge or discharge electricity.

With the recent trend of down-sizing and thin film of electron products, demand for high-capacity capacitors is increasing compared to the existing stacked capacitor.

### SUMMARY

At least one of embodiments is to provide a capacitor having high-capacity, and a manufacturing method thereof.

However, the problems to be solved through embodiments of the present disclosure are not limited to the above-mentioned problems and may be expanded in various ways within the scope of technical ideas included in the present disclosure.

A capacitor according to one aspect includes: a substrate including a groove having a depth from an upper surface of the substrate; and a body including a first internal electrode and a second internal electrode stacked disposing a dielectric layer therebetween, and disposed on the groove. A width of the groove may be 1 time or more compared to the depth of the groove and a length of the groove may be 1 time or more compared to the depth of the groove.

The capacitor may further include a first external electrode disposed on an upper surface of one end portion of the body in a length direction; and a second external electrode disposed on an upper surface of the other end portion of the body in the length direction.

The body may further include a first electrode separation layer disposed between the first external electrode and the second internal electrode.

One end portion of the second internal electrode may have a structure of being recessed into an inner side of the groove at one end portion of the body in the length direction, and the first electrode separation layer may be disposed in a space between two adjacent dielectric layers.

The body may further include a second electrode separation layer disposed between the second external electrode and the first internal electrode.

One end portion of the first internal electrode may have a structure of being recessed into an inner side of the groove at the other end portion of the body in the length direction, the second electrode separation layer may be disposed in a space between two adjacent dielectric layers.

The capacitor may further include a lower insulation layer disposed between the groove and the body.

The capacitor may further include: a first external electrode connected to the first internal electrode on an upper surface of the body; a second external electrode connected to the second internal electrode on the upper surface of the body; and an insulating layer that is disposed on a portion other than a portion where the first external electrode and the second external electrode are disposed on an outer circumference of the upper surface of the body.

The groove may have a structure in which one side in a width direction is open to a side surface direction of the substrate, and one side of the body in the width direction may be disposed on the side surface of the substrate.

The substrate may include a longitudinal ridge portion that protrudes upward from a bottom surface of the groove and is disposed to be spaced apart from a width direction side of the groove.

The substrate may include a transverse ridge portion that protrudes upward from a bottom surface of the groove and is disposed to be spaced apart from a length direction side of the groove.

The capacitor may further include: a first external electrode connected to the first internal electrode on an upper surface of the body; and a second external electrode connected to the second internal electrode on an upper surface of the body. A boundary between the body and the substrate in a lower area of the first external electrode and the second external electrode may be inclined with respect to the upper surface of the substrate.

The width of the groove may be 1 time or more and 44 or less compared to the depth of the groove, and the length of the groove may be 1 time or more and 54 or less compared to the depth of the groove.

The depth of the groove may be 100 um or less.

The first internal electrode and the second internal electrode may be disposed only in the groove.

A capacitor manufacturing method according to another aspect includes: forming a groove that is recessed from an upper surface of a substrate in a direction towards a bottom surface of the substrate; forming an internal electrode layer and a dielectric layer on the upper surface of the substrate and on the groove; forming a body on the groove to include an internal electrode formed through the internal electrode layer and the dielectric layer, by removing portions, disposed outside the groove, among the internal electrode layer and the dielectric layer; and forming an external electrode connected with the internal electrode on the body.

The removing the portions of the internal electrode layer and the dielectric layer may be performed through a polishing process.

A capacitor according to another aspect includes: a substrate including a groove having a depth from an upper surface of the substrate; and a body comprising a first internal electrode and a second internal electrode stacked disposing a dielectric layer therebetween, and disposed on the groove. The first internal electrode and the second internal may be disposed only in the groove.

The capacitor may further include: a first external electrode disposed on an upper surface of one end portion of the body and the upper surface of the substrate to connect to the first internal electrode; and a second external electrode disposed on an upper surface of the other end portion of the body and the upper surface of the substrate to connect to the second internal electrode.

The capacitor may further include: a first electrode separation layer disposed between the first external electrode and the second internal electrode; and a second electrode separation layer disposed between the second external electrode and the first internal electrode.

According to at least one of the embodiments, a capacitor having high-capacity, and a manufacturing method thereof can be provided.

### BRIEF DESCRIPTION OF THE DRAWINGS

FIG. 1 shows a capacitor according to an embodiment.

FIG. 2 is a vertical cross-sectional view of the capacitor of FIG. 1 in a width direction.

FIG. 3 is a vertical cross-sectional view of the capacitor of FIG. 1 in a length direction.

FIG. 4 to FIG. 11 show a manufacturing method of a capacitor according to an embodiment.

FIG. 12 is a vertical cross-sectional view of a capacitor in a width direction according to another embodiment.

FIG. 13 is a vertical cross-sectional view of a capacitor in a length direction according to another embodiment.

FIG. 14 is a top plan view that shows a dicing line for dicing in a manufacturing method of a capacitor according to another embodiment.

FIG. 15 shows one end portion of a vertical cross-sectional view of a capacitor manufactured according to the manufacturing method of FIG. 14 in a width direction.

FIG. 16 is a top plan view illustrating a dicing line for dicing in a manufacturing method of a capacitor according to another embodiment.

### DETAILED DESCRIPTION OF THE EMBODIMENTS

In the following detailed description, only certain exemplary embodiments of the present disclosure have been illustrated and described, simply by way of illustration. As those skilled in the art would realize, the described exemplary embodiments may be modified in various different ways, all without departing from the spirit or scope of the present disclosure.

In order to clearly explain the present disclosure, parts without explanation and relationship are omitted, and the same reference sign is used for identical or similar components throughout the specification.

In addition, the size and thickness of each component shown in the drawing are arbitrarily shown for better understanding and ease of description, and thus the present disclosure is not necessarily limited to what is shown. In the drawings, the thickness of layers, films, panels, regions, and the like are exaggerated for clarity. In addition, in the drawings, the thickness of some layers and areas is exaggerated for better understanding and ease of description.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “above” or “on” a reference portion, the element is located above or below the reference portion, and it does not necessarily mean that the element is located “above” or “on” in a direction opposite to gravity.

In addition, unless explicitly described to the contrary, the word “comprise”, and variations such as “comprises” or “comprising”, will be understood to imply the inclusion of stated elements but not the exclusion of any other elements.

Further, in the entire specification, when it is referred to as “on a plane”, it means when a target part is viewed from above, and when it is referred to as “on a cross-section”, it means when the cross-section obtained by cutting a target part vertically is viewed from the side.

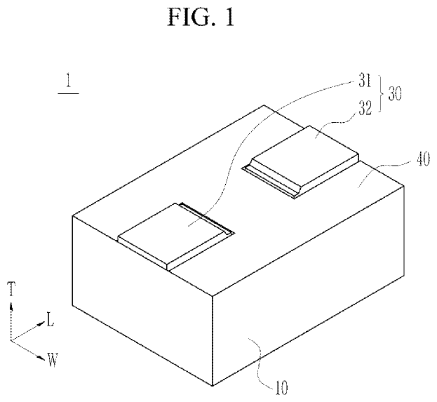

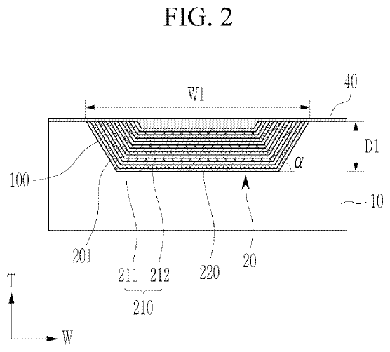

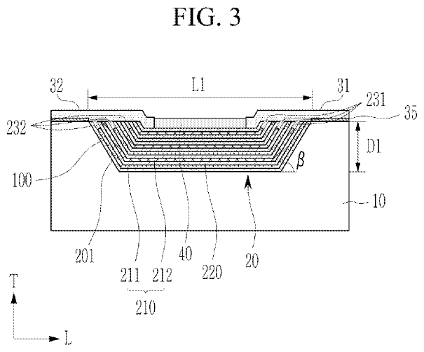

FIG. 1 shows a capacitor according to an embodiment, FIG. 2 is a vertical cross-sectional view of the capacitor of FIG. 1 in a width direction W, and FIG. 3 is a vertical cross-sectional view of the capacitor of FIG. 1 in a length direction L.

Referring to FIG. 1 to FIG. 3, a capacitor 1 according to an embodiment may include a substrate 10, a body 20, and an external electrode 30.

The substrate 10 has a predetermined area. The substrate 10 may be formed of an insulating material. The substrate 10 may be a silicon substrate and the like. The substrate 10 includes an upper surface and a lower surface that face each other. The substrate 10 has a predetermined thickness in a vertical direction T along which the upper surface and the lower surface are separated from each other.

The thickness of the substrate 10 may be larger than 100 um. The substrate 10 may have a predetermined width in a width direction W that crosses the vertical direction T. The width direction W may be orthogonal to the vertical direction T. The substrate 10 may have a predetermined length in a length direction L crossing the vertical direction T and the width direction W. The length direction L may be orthogonal to the vertical direction T and the width direction W. The length of substrate 10 may be larger than the width of the substrate 10. For example, the length of the substrate 10 may be 1.5 times or more and 2.5 times or less compared to the width of the substrate 10. The substrate 10 may have a general shape of a hexahedron.

A body accommodating groove 100 (e.g., a groove for accommodating body) is formed on the upper surface of the substrate 10.

The body accommodating groove 100 has a structure that goes into a predetermined depth from the upper surface of the substrate 10 to the lower surface. The body accommodating groove 100 may have a first depth D1 in the vertical direction T. The first depth D1 of the body accommodating groove 100 may be a distance between the upper surface of the substrate 10 and a point that is the most adjacent to the lower surface of the substrate 10 in the body accommodating groove 100.

The body accommodating groove 100 may have a predetermined width in the width direction W. A width W1 of the body accommodating groove 100 may be a distance between both ends of which the distance along the width direction W is the greatest. The width W1 of the body accommodating groove 100 may be measured at an upper end of the body accommodating groove 100.

A side surface of the body accommodating groove 100 in the width direction W may be inclined by a first angle α with respect to the horizontal direction. The first angle α may be a slope of a straight line connecting the top and bottom of the side surface of the body accommodating groove 100 in the width direction W. The first angle α may have a value of 90° or less.

The width W1 of the body accommodating groove 100 is provided as 1 time or more compared to the first depth D1 of the body accommodating groove 100. For example, the width W1 of the body accommodating groove 100 of the body accommodating groove may be 1 time or more and 44 times or less compared to the first depth D1 of the body accommodating groove 100. The first depth D1 of the body accommodating groove 100 may be 100 um or less. In addition, the width W1 of the body accommodating groove 100 may be 100 um or more. The width W1 of the body accommodating groove 100 may be 100 um or more and 1300 um or less.

The body accommodating groove 100 may have a predetermined length L1 in the length direction L. The length L1 of the body accommodating groove 100 may be a distance between the two ends with the greatest distance along the length direction L. The length L1 of the body accommodating groove 100 may be measured at the top of the body accommodating groove 100.

The side surface of the body accommodating groove 100 in the length direction L may be inclined by a second angle β with respect to the horizontal direction. The second angle β may be the slope of a straight line connecting the top and bottom of the side surface of the body accommodating groove 100 in the length direction L. The second angle β may have a value of 90° or less.

The length L1 of the body accommodating groove 100 is provided as 1 time or more compared to the first depth D1 of the body accommodating groove 100. As an example, the length L1 of the body accommodating groove 100 may be 1 time or more and 54 times or less compared to the first depth D1 of the body accommodating groove 100. The first depth D1 of the body accommodating groove 100 may be 100 um or less. In addition, the length L1 of the body accommodating groove 100 may be 100 um or more. The length L1 of the body accommodating groove 100 may be 100 um or more and 1600 um or less. The length L1 of the body accommodating groove 100 may be larger than the width W1 of the body accommodating groove 100.

The body 20 is disposed inside body accommodating groove 100. The body 20 includes an internal electrode 210 and a dielectric layer 220.

The internal electrode 210 is stacked inside the body accommodating groove 100. The internal electrode 210 is provided as a conductive material. The internal electrode 210 may be formed of a metallic material. An end portion of the internal electrode 210 in the width direction W may be inclined upward toward the outside corresponding to the side surface of the body accommodating groove 100 in the width direction W. An end portion of the internal electrode 210 in the length direction L may be inclined upward toward the outside corresponding to the side surface of the body accommodating groove 100 in the length direction L.

The dielectric layer 220 is disposed between internal electrodes 210 that are adjacent to each other in the vertical direction T. In addition, the dielectric layer 220 may be disposed on the internal electrode 210 disposed on the top. The dielectric layer 220 may be formed of one of oxidation materials such as Al₂O₃ ZrO₂, HfO₂, AlN, and the like. Alternatively, the dielectric layer 220 may be formed of a combination of oxidation materials such as Al₂O₃ ZrO₂, HfO₂, AlN, and the like. Alternatively, the dielectric layer 220 may be formed of ZAZ, which is a ZrO₂—Al₂O₃—ZrO₂ composite layer.

The internal electrode 210 may include a first internal electrode 211 and a second internal electrode 212.

The first internal electrode 211 and the second internal electrode 212 are stacked inside the body accommodating groove 100. The first internal electrode 211 and the second internal electrode 212 may be alternately stacked. The dielectric layer 220 may be disposed between the first internal electrode 211 and the second internal electrode 212. The first internal electrode 211 and the second internal electrode 212 are provided as conductive materials. The first internal electrode 211 may be a metallic material. The second internal electrode 212 may be a metallic material. The first internal electrode 211 and the second internal electrode 212 may be formed of different materials. Accordingly, the first internal electrode 211 and the second internal electrode 212 may experience selective etching. For example, the first internal electrode 211 may include molybdenum, and the second internal electrode 212 may include titanium.

A lower insulation layer 201 may be disposed between the body accommodating groove 100 and the body 20. That is, the lower insulation layer 201 may be disposed on the body accommodating groove 100, and the body 20 may be disposed on the lower insulation layer 201. The first internal electrode 211 or the second internal electrode 212 may be disposed on the lower insulation layer 201. The lower insulation layer 201 may be silicon oxide (SiO₂) and the like.

The external electrode 30 is connected to the internal electrode 210 of the body 20. The external electrode 30 may be disposed on the body 20. In addition, some area of the external electrode 30 may be disposed on the substrate 10. In this case, an upper insulation layer 35 may be disposed between the external electrode 30 and the substrate 10. The upper insulation layer 35 may be alumina (Al₂O₃), silicon oxide (SiO₂), and the like.

A boundary between the body 20 and the substrate 10 in a lower area of the external electrode 30 may be inclined with respect to the horizontal direction that is orthogonal to the vertical direction T. In addition, a boundary between the body 20 and the substrate 10 in the lower area of the external electrode 30 may be inclined with respect to the vertical direction T and the horizontal direction.

The external electrode 30 includes a first external electrode 31 and a second external electrode 32.

The first external electrode 31 is disposed on an upper surface of the body 20. The first external electrode 31 may be disposed on an upper surface of one end portion of the body 20 in the length direction L. A boundary between the body 20 and the substrate 10 in a lower area of the first external electrode 31 may be inclined with respect to the horizontal direction that is orthogonal to the vertical direction T. In addition, a portion of the first external electrode 31 may be disposed on the upper surface of the substrate 10. The first external electrode 31 is connected to the first internal electrode 211. That is, the first external electrode 31 is disposed on the upper surface of the body 20, and is connected to the first internal electrode 211 exposed through the upper surface of the body 20. That is, the first external electrode 31 may be directly connected to one end of the first internal electrode 211 exposed on the upper surface of the body 20.

A first electrode separation layer 231 is disposed at an outer side of one end of the second internal electrode 212 at one end portion of the body 20 in the length direction L. That is, one end portion of the second internal electrode 212 may have a structure that goes inside the body accommodating groove 100 at one end portion of the body 20 in the length direction L. In addition, as the second internal electrode 212 has a structure that goes inside the body accommodating groove 100, the first electrode separation layer 231 may be disposed in a space formed between the two adjacent dielectric layers 220. The first electrode separation layer 231 is provided as an insulating material. For example, the first electrode separation layer 231 may be provided as alumina (Al₂O₃), a silicon oxide, and the like. Accordingly, the first electrode separation layer 231 is disposed between the first external electrode 31 and the second internal electrode 212. The first external electrode 31 is electrically separated from the second internal electrode 212 by the first electrode separation layer 231.

The second external electrode 32 is disposed on an upper surface of the body 20. The second external electrode 32 may be disposed on an upper surface of the other end portion of the body 20 in the length direction L. A boundary between body 20 and the substrate 10 in the lower area of the second external electrode 32 may be inclined with respect to the horizontal direction that is orthogonal to the vertical direction T. In addition, a portion of the second external electrode 32 may be disposed on an upper surface of the substrate 10. The second external electrode 32 is connected to the second internal electrode 212. That is, the second external electrode 32 is disposed on the upper surface of the body 20 and thus connected to the second internal electrode 212 exposed through the upper surface of the body 20. That is, the second external electrode 32 may be directly connected to one end of the second internal electrode 212 exposed on the upper surface of the body 20.

At the other end portion of the body 20 in the length direction L, the second electrode separation layer 232 is disposed at one end of the first internal electrode 211. That is, at the other end portion of the body 20 in the length direction L, one end portion of the first internal electrode 211 may have a structure that goes inside the body accommodating groove 100. In addition, as the first internal electrode 211 has a structure that goes inside the body accommodating groove 100, the second electrode separation layer 232 may be disposed in a space formed between the two adjacent dielectric layers 220. The first electrode separation layer 231 and the second electrode separation layer 232 may be positioned in opposite directions with a central area of the body 20 disposed therebetween. The second electrode separation layer 232 is provided as an insulating material. For example, the second electrode separation layer 232) may be provided as alumina (Al₂O₃), silicon oxide, and the like. Accordingly, the second electrode separation layer 232 is disposed between the second external electrode 32 and the first internal electrode 211. The second external electrode 32 is electrically separated from the first internal electrode 211 by the second electrode separation layer 232.

An insulating layer 40 may be disposed on a portion other than the portion where the external electrode 30 is disposed in an external circumference of the upper surface of the body 20. That is, the insulating layer 40 is disposed on the upper surface of the body 20 in an area other than the area where the external electrode 30 is disposed among the areas where the end of the internal electrode 210 is exposed, thereby insulating the internal electrode 210 from the outside. For example, the insulating layer 40 may be formed to cover a portion other than the portion where the external electrode 30 is disposed on the upper surface of the body 20. In addition, the insulating layer 40 may be disposed on the upper surface of the substrate 10. FIG. 1 exemplarily illustrates a case that the insulating layer 40 is disposed on the portion other than the portion where the external electrode 30 is disposed on the upper surface of the body 20 and on the upper surface of the substrate 10. The insulating layer 40 may be provided as alumina (Al₂O₃), silicon oxide, and the like.

According to an embodiment, the capacitor 1 has a structure in which the body 20 forming capacitance is accommodated in the body accommodating groove 100 formed in the substrate 10. Accordingly, the substrate 10 and the body 20 can be stably combined to each other.

In addition, according to an embodiment, the capacitor 1 has a structure in which the body 20 is accommodated in the body accommodating groove 100 formed in the substrate 10, and thus the capacitor 1 may have high capacity while having a thin thickness.

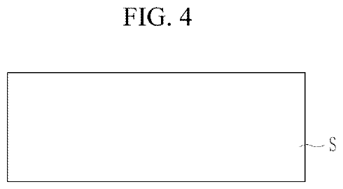

FIG. 4 to FIG. 11 show a manufacturing method of a capacitor according to an embodiment.

Hereinafter, a manufacturing method of the capacitor 1 according to an embodiment will be described with reference to FIG. 4 to FIG. 11.

Referring to FIG. 4, a substrate S is provided. The substrate S may be a silicon substrate and the like. The substrate S may be provided with an area larger than that of the two body accommodating grooves 100. Accordingly, a plurality of body accommodating grooves 100 may be formed on one substrate S. For convenience of illustration, FIG. 4 illustrates an area where one body accommodating groove 100 is formed in the substrate S.

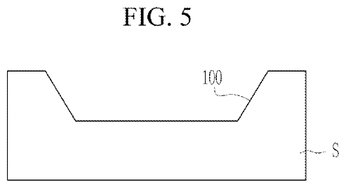

Referring to FIG. 5, a body accommodating groove 100 formed in the downward direction is formed on the upper surface of substrate S. The body accommodating groove 100 may be formed through an etching process. As the etching process, a wet etching process using chemical, dry etching process using plasma, and the like may be used. When the etching process is carried out through wet etching, a side wall of the body accommodating groove 100 may have an inclination of about 54° or more or about 55° or less. When the etching process is performed through dry etching, the inclination of the sidewall of the body accommodating groove 100 may be adjusted to about 54° or more or about 55° or less.

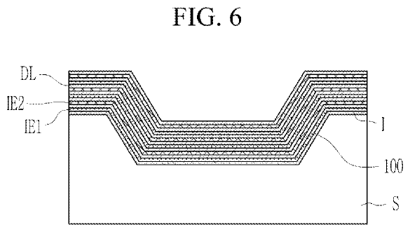

Referring to FIG. 6, internal electrode layers IE1 and IE2 and a dielectric layer DL are formed on the substrate S to form the body 20. The internal electrode layers IE1 and IE2 and the dielectric layer DL may be alternately formed. To form the body 20, the internal electrode layers IE1s and IE2 are formed first, and then the dielectric layers DL and the internal electrode layers IE1 and IE2 may be formed alternately. In the internal electrode layers IE1 and IE2 and the dielectric layer DL for forming the body 20, the dielectric layer DL may be formed at the very end. Accordingly, the dielectric layer DL may be disposed on the internal electrode layers IE1, and IE2 positioned at the top.

The internal electrode layers IE1 and IE2 and the dielectric layer DL may be formed through a deposition process. A chemical vapor deposition (CVD), an atomic layer deposition (ALD) and the like may be used to form the internal electrode layers IE1 and IE2. The CVD, the ALD, and the like may be used to form the dielectric layer DL.

The internal electrode layers IE1 and IE2 may include a first internal electrode layer IE1 and a second internal electrode layer IE2. The first internal electrode layer IE1 and the second internal electrode layer IE2 may be alternately formed. Different materials may be used for forming the first internal electrode layer IE1 and the second internal electrode layer IE2. For example, the first internal electrode layer IE1 may be formed using molybdenum and the second internal electrode 212 may be used using the titanium.

In addition, a lower insulation layer I may be formed on the substrate S before forming the internal electrode layers IE1 and IE2. After that, the internal electrode layers IE1 and IE2 and the dielectric layer DL for forming the body 20 may be formed on the lower insulation layer I. In order to form the lower insulation layer I, a CVD process, an ALD process, and the like may be used. In addition, the lower insulation layer I may be formed ion injection with respect to the substrate S. For example, the lower insulation layer I may be silicon oxide (SiO₂) and the like.

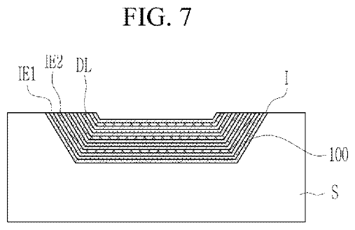

Referring to FIG. 7, among the internal electrode layers IE1 and IE2 and the dielectric layer DL, an area formed outside the body accommodating groove 100 is removed. It may be understood that the area formed outside the body accommodating groove 100 is a portion formed in an area higher than the upper surface of the substrate S. The removal of the internal electrode layers IE1 and IE2 and the dielectric layer DL may be carried out through a polishing process. For example, the internal electrode layers IE1 and IE2 and the dielectric layer DL may be removed through a chemical mechanical polishing (CMP).

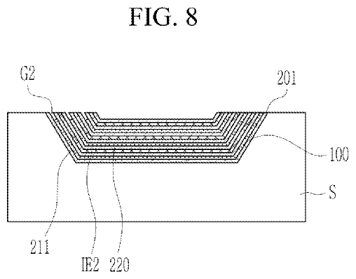

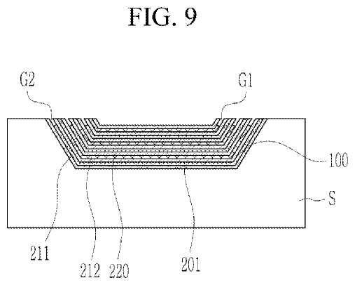

Referring to FIG. 8 and FIG. 9, the first internal electrode layer IE1 and the second internal electrode layer IE2 are etched at both ends of the body accommodating groove 100 in the length direction L, respectively, to form a second separation gap G2 and a first separation gap G1. That is, one end of the first internal electrode layer IE1 is etched at the other end of the body accommodating groove 100 in the length direction L to form the first internal electrode 211 with one end entering the inside of the body accommodating groove 100 by the second separation gap G2. Then, one end of the second internal electrode layer IE2 is etched at one end of the body accommodating groove 100 in the length direction L to form the second internal electrode 212 with one end entering the inside of the body accommodating groove 100 by the first separation gap G1. Since the first internal electrode layer IE1 and the second internal electrode layer IE2 are provided as different materials, the first internal electrode layer IE1 and the second internal electrode layer IE2 may be selectively etched. For etching of the first internal electrode layer IE1, dry etching using plasma or wet etching using chemicals may be used. For etching of the second internal electrode layer IE2, dry etching using plasma or wet etching using chemicals may be used. After the first internal electrode layer IE1 is etched, the second internal electrode layer IE2 may be etched. Alternatively, the first internal electrode layer IE1 may be etched after the second internal electrode layer IE2 is etched.

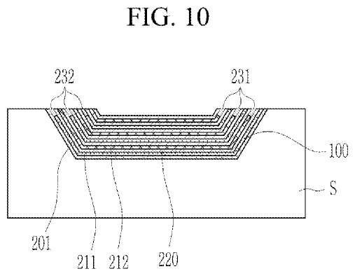

Referring to FIG. 10, the first separation gap G1 and the second separation gap G2 are filled with an insulating material to form the first electrode separation layer 231 and the second electrode separation layer 232. The CVD, the ALD, and the like may be used to fill the insulating material.

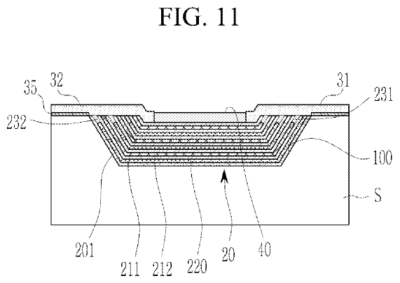

Referring to FIG. 11, the external electrode 30 is formed on the body 20 on which the internal electrode 210, the first electrode separation layer 231, and the second electrode separation layer 232 are formed. The first external electrode 31 is formed on a portion where the first electrode separation layer 231 is formed in the body 20. Accordingly, the first external electrode 31 is connected to the first internal electrode 211 on an end of one side of the body 20 and electrically separated from the second internal electrode 212.

The second external electrode 32 is formed on a portion where the second electrode separation layer 232 is formed in the body 20. Accordingly, the second external electrode 32 is connected to the second internal electrode 212 at an end of the other side of the body 20 and electrically separated from the first internal electrode 211.

In addition, some area of the first external electrode 31 and some area of the second external electrode 32 may be formed on the substrate S. In this case, before forming the first external electrode 31 and the second external electrode 32, the upper insulation layer 35 may be formed in the area where the first external electrode 31 and the second external electrode 32 are to be formed on the substrate S. The upper insulation layer 35 may be formed of alumina (Al₂O₃), silicon oxide (SiO₂), and the like.

In addition, the insulating layer 40 may be formed in an area other than areas where the external electrode 20 is disposed on the upper surface of the body 20. In this case, the insulating layer 40 may be formed after the external electrode 30 is formed. Alternatively, the insulating layer 40 may be formed before the external electrode 30 is formed. In this case, the insulating layer 40 may be formed together with the upper insulation layer 35 before the external electrode 30 is formed. Alternatively, the insulating layer 40 may be formed when the first separation gap G1 and the second separation gap G2 are filled with an insulation material before the external electrode 30 is formed.

After that, when a plurality of bodies 20 are formed on the substrate S, each area where the body 20 of the substrate S is formed may be diced.

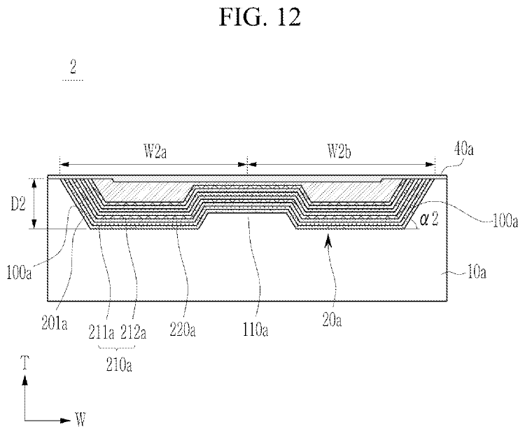

FIG. 12 is a vertical cross-sectional view of a capacitor 2 in a width direction W according to another embodiment.

Referring to FIG. 12, a body accommodating groove 100a is formed on an upper surface of a substrate 10a. The body accommodating groove 100a may have a predetermined depth in a vertical direction T. A first depth D2 of the body accommodating groove 100a may be a distance between an upper surface of a substrate 10a and a point that is the most adjacent to a bottom surface of the substrate 10a in the body accommodating groove 100a.

A side surface of the body accommodating groove 100a in a width direction W may be inclined by a first angle a2 with respect to the horizontal direction. The first angle a2 may be a slope of a straight line connecting the top and bottom of the side surface of the body accommodating groove 100a in the width direction W. The first angle a2 may have a value of 90° or less.

The body accommodating groove 100a may include a first longitudinal partitioning portion W2a and a second longitudinal partitioning portion W2b.

The first longitudinal partitioning portion W2a and the second longitudinal partitioning portion W2b may be disposed adjacent to each other in the width direction W of the capacitor 2 (and the body accommodating groove 100a and the body 20a). In the substrate 10a, a longitudinal ridge portion 110a is disposed in an area where the first longitudinal partitioning portion W2a and the second longitudinal partitioning portion W2b are adjacent to each other. The longitudinal ridge portion 110a is disposed to protrude to a predetermined length upward from the bottom of the body accommodating groove 100a. An upper end of the longitudinal ridge portion 110a is disposed lower than the upper surface of the substrate 10a. The vertical direction T distance from the top of the longitudinal ridge portion 110a to the top surface of the substrate 10a is smaller than the first depth D2 of the body accommodating groove 100a. The longitudinal ridge portion 110a is disposed to be distanced from the side surface of the body accommodating groove 100a in the width direction W. The longitudinal ridge portion 110a may have a predetermined length along the length direction L.

The first longitudinal partitioning portion W2a may have a first width in the width direction W. The second longitudinal partitioning portion W2b may have a second width in the width direction W. The first width may be a distance between one end of the body accommodating groove 100a to a center of the longitudinal ridge portion 110a in the width direction W. The second width may be a distance between the other end of the body accommodating groove 100a and the center of the longitudinal ridge portion 110a in the width direction W.

The first width may be provided as 1 time or more compared to the first depth D2 of the body accommodating groove 100a. The second width may be provided as 1 time or more compared to the first depth D2 of the body accommodating groove 100a.

The body 20a is disposed in an inner side of the body accommodating groove 100a. The body 20a includes a first internal electrode 211a, a second internal electrode 212a, and a dielectric layer 220a. The body 20a corresponds to the shape of the body accommodating groove 100a, and a vertical direction dimension of an area disposed on the longitudinal ridge portion 110a is smaller than a thickness D2.

A lower insulation layer 201a may be disposed between the body accommodating groove 100a and the body 20a.

An insulating layer 40a may be disposed on the body 20a. In addition, the insulating layer 40a may be disposed on the substrate 10a. Since the capacitor 2 is the same as or similar to the capacitor 1 of FIG. 1 to FIG. 3 except that the longitudinal ridge portion 110a is disposed in the substrate 10a and thus an area where the size of the body accommodating groove 100a and the size of the body 20a are reduced in the vertical direction T along the width direction W is formed, the duplicated description will be omitted.

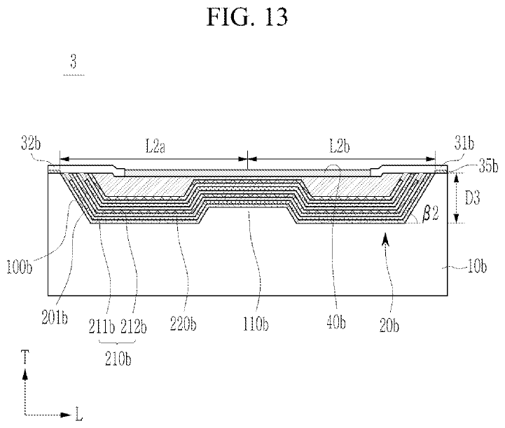

FIG. 13 is a vertical cross-sectional view of a capacitor 3 in a length direction L according to another embodiment.

Referring to FIG. 13, a body accommodating groove 100b is formed on an upper surface of a substrate 10b. The body accommodating groove 100b may have a predetermined depth in a vertical direction T. A first depth D3 of the body accommodating groove 100b may be a distance between the upper surface of the substrate 10b and a point closest to a lower surface of the substrate 10b in the body accommodating groove 100b.

A side surface of the body accommodating groove 100b in a length direction L may be inclined by a second angle 32 with respect to the horizontal direction. The second angle 32 may be a slope that connects an upper end and a lower end of the side surface of the body accommodating groove 100b in the length direction L. The second angle 32 may have a value of 90° or less.

The body accommodating groove 100b may include a first transverse partitioning portion L2a and a second transverse partitioning portion L2b.

The first transverse partitioning portion L2a and the second transverse partitioning portion L2b are disposed adjacent to each other in a length direction L of the capacitor 3 (and the body accommodating groove 100b and the body 20b). In the substrate 10b, a transverse ridge portion 110b may be disposed in an area where the first transverse partitioning portion L2a and the second transverse partitioning portion L2b are adjacent to each other. The transverse ridge portion 110b is disposed to protrude to a predetermined length upward from the bottom of the body accommodating groove 100b. An upper end of the transverse ridge portion 110b is disposed lower than the upper surface of the substrate 10b. A distance from an upper end of the transverse ridge portion 110b to the upper surface of the substrate 10b in the vertical direction T is smaller than a first depth D3 of the body accommodating groove 100b. The transverse ridge portion 110b is disposed to be separated from the side surface of the body accommodating groove 100b in the length direction L. The transverse ridge portion 110b may have a predetermined length in the width direction W.

The first transverse partitioning portion L2a may have a first length in the length direction L. The second transverse partitioning portion L2b may have a second length in the length direction L. The first length may be a distance from one end of the body accommodating groove 100b to a center of the transverse ridge portion 110b in the length direction L. The second length may be a distance from the other end of the body accommodating groove 100b to the center of the transverse ridge portion 110b in the length direction L.

The first length may be provided as 1 time or more compared to the first depth D3 of the body accommodating groove 100b. The second length may be provided as 1 time or more compared to the first depth D3 of the body accommodating groove 100b.

The body 20b is disposed in an inner side of the body accommodating groove 100b. The body 20b includes a first internal electrode 211b, a second internal electrode 212b, and a dielectric layer 220b. The body 20b corresponds to the shape of the body accommodating groove 100b, and a vertical direction dimension of an area disposed on the transverse ridge portion 110b is smaller than a thickness D3.

A lower insulation layer 201b may be disposed between the body accommodating groove 100b and the body 20b.

The first external electrode 31b and the second external electrode 32b are disposed on the body 20b. The first external electrode 31b is connected to the first internal electrode 211b. The second external electrode 32b is connected to the first internal electrode 211b.

An insulating layer 40b may be disposed on the body 20b. In addition, the insulating layer 40b may be disposed on the substrate 10b. Since the capacitor 3 is the same as or similar to the capacitor 1 of FIG. 1 to FIG. 3 except that the longitudinal ridge portion 110b is disposed in the substrate 10b and thus an area where the size of the body accommodating groove 100b and the size of the body 20b are reduced in the vertical direction T along the length direction L is formed, the duplicated description will be omitted.

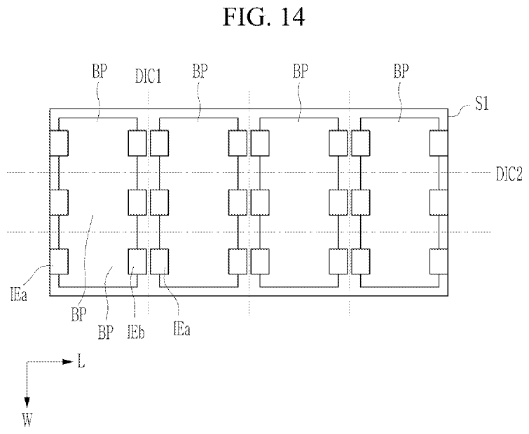

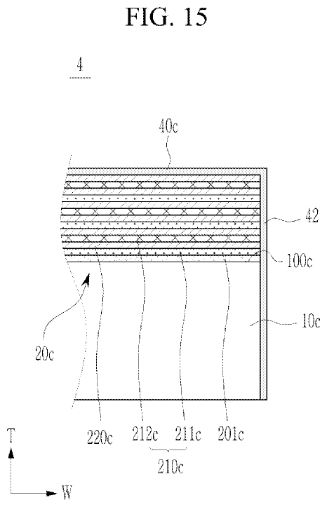

FIG. 14 is a top plan view that shows a dicing line for dicing in a manufacturing method of a capacitor according to another embodiment, and FIG. 15 shows one end portion of a vertical cross-sectional view of a capacitor 4 manufactured according to the manufacturing method of FIG. 14 in a width direction W.

Referring to FIG. 14 and FIG. 15, a substrate S1 may be diced along a first dicing line DIC1 in a width direction W and a second dicing line DIC2 in a length direction L. Accordingly, the substrate S1 is separated along the first dicing line DIC1 and the second dicing line DIC2, and thus each of the separated areas becomes a substrate 10C of a capacitor 4.

Before the dicing, a body forming portion BP is formed on the substrate S1. A first external electrode forming portion IEa and a second external electrode forming portion IEb are formed on the body forming portion BP. A part of the first external electrode forming portion IEa may be formed on the substrate S1. A part of the second external electrode forming portion IEb may be formed on the substrate S1. The body forming portion BP becomes a body 20c of the capacitor 4 after dicing is completed. The first external electrode forming portion IEa becomes a first external electrode after the dicing is completed. The second external electrode forming portion IEb becomes a second external electrode after the dicing is completed.

In a method for manufacturing the body forming portion BP, the first external electrode forming portion IEa, and the second external electrode forming portion IEb, portions that are the same as or similar to the method described with reference to FIG. 4 to FIG. 11 are omitted, and only differences will be described.

A body accommodating groove 100c is formed on the substrate S1. In this case, two body accommodating grooves 100c adjacent to each other in the width direction W are formed to be connected with each other. Accordingly, a body c formed in each body accommodating groove 100c is connected to one another, thereby forming one body forming portion BP.

Then, the body forming portion BP is separated from each other through dicing, thereby forming the bodies 20c, respectively. Accordingly, after the dicing is completed, the body accommodating groove 100c has a structure in which one side surface in the width direction W is open in a side surface direction of the substrate 10c. In addition, one end of the first internal electrode 211c and one end of the second internal electrode 212c may be disposed on the side surface of the substrate 10c along the width direction W. That is, one side surface of the body 20c in the width direction W may be disposed on the side surface of the substrate 10c. Accordingly, a side surface insulating layer 42 may be formed to prevent external exposure of the internal electrode 210a on the side surface in the width direction W of the capacitor 4, diced along the second dicing line DIC2. Accordingly, the side insulating layer 40 is disposed on one side surface in the width direction W of the body 20c disposed on the side surface of the substrate 10c. The side surface insulating layer 42 may be formed after the dicing process is carried out.

Since the structure of the capacitor 4 is the same as or similar to the structure of the capacitor 1 of FIG. 1, except that one side of the body accommodating groove 100c in the width direction W is opened toward the width direction W of the capacitor 4, this will not be described.

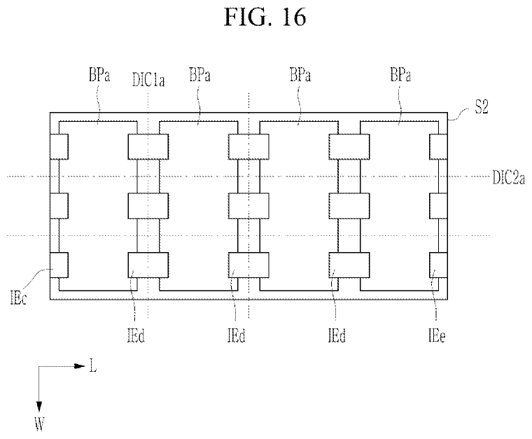

FIG. 16 is a top plan view illustrating a dicing line for dicing in a manufacturing method of a capacitor according to another embodiment.

Referring to FIG. 16, a substrate S2 may be diced along a first dicing line DIC1a in a width direction W and a second dicing line DIC2a in a length direction L. Accordingly, the substrate S2 is separated along the first dicing line DIC1a and the second dicing line DIC2a, and each of the separated areas becomes a capacitor 4.

Before dicing, a body forming portion BPa is formed on the substrate S2. A first external electrode forming portion IEc, an external electrode forming portion for dicing IEd, and a second external electrode forming portion IEe are formed on the body forming portion BPa. A part of the first external electrode forming portion IEc may be formed on the substrate S2. A part of the external electrode forming portion for dicing IEd may be formed on the substrate S2. The external electrode forming portion for dicing IEd may be formed over two body forming portions PBa that are adjacent to each other in the length direction L. Accordingly, the first dicing line DIC1a is disposed across the external electrode forming portion for dicing IEd. A part of the second external electrode forming portion IEe may be formed on the substrate S2. After the dicing is completed, the body forming portion BPa becomes a body 20c of the capacitor 4. After the dicing is complete, the first external electrode forming portion IEc becomes a first external electrode. After the dicing is complete, the second external electrode forming portion IEe becomes a second external electrode. The external electrode forming portion for dicing IEd is separated through dicing and thus one side becomes a first external electrode and the other side becomes a second external electrode.

In a method for manufacturing the body forming portion BPa, the first external electrode forming portion IEc, the external electrode for dicing IEd, and the second external electrode forming portion IEe, the contents that are that same as or similar to the method described with reference to FIG. 4 to FIG. 11 will be omitted, and differences will be described.

A body accommodating groove 100c is formed on the substrate S2. In this case, two body accommodating grooves 100c that are adjacent to each other along the width direction W are formed to be connected with each other. Accordingly, the body 20c formed in each of the body accommodating grooves 100c is connected to one another such that one body forming portion BPa is formed.

Then, the body forming portion BPa is separated from each other through dicing and each body forming portion BPa forms a body 20c. Accordingly, after dicing is completed, the body accommodating groove 100c has a structure in which one side in the width direction W is open to a side surface of the capacitor 4 in the width direction W. In this case, the structure of body 20c manufactured through the dicing of the body forming portion BPa is the same or similar to the structure described with reference to FIG. 15, and therefore duplicated description will be omitted.

In addition, the external electrode forming portion for dicing IEd is formed over two body forming portions PBa that are adjacent to each other in the length direction L. Accordingly, the external electrode forming portion for dicing IEd in one body forming portion BPa is connected to a second internal electrode 212c and the external electrode forming portion for dicing IEd in the other body forming portion BPa is connected to a first internal electrode 211c. Then, the external electrode forming portion for dicing IEd is diced together with the substrate S2 during the dicing process, and thus one side becomes the second external electrode on one capacitor 4 and the other side becomes the first external electrode on the other capacitor 4. In addition, depending on the dicing of the external electrode forming portion for dicing IEd, a dicing pattern generated during the dicing process may be positioned on at least one of the first external electrode and the second external electrode. In this case, the dicing pattern may be a pattern that occurs due to friction with a blade during the dicing process. In addition, the dicing pattern may be a crack pattern generated during the dicing process using a laser.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A capacitor comprising:
a substrate including a groove having a depth from an upper surface of the substrate; and
a body comprising a first internal electrode and a second internal electrode stacked disposing a dielectric layer therebetween, and disposed on the groove,
wherein a width of the groove is 1 time or more compared to the depth of the groove, and a length of the groove is 1 time or more compared to the depth of the groove.

2. The capacitor of claim 1, further comprising:
a first external electrode disposed on an upper surface of one end portion of the body in a length direction; and
a second external electrode disposed on an upper surface of the other end portion of the body in the length direction.

3. The capacitor of claim 2, wherein:
the body further comprises a first electrode separation layer disposed between the first external electrode and the second internal electrode.

4. The capacitor of claim 3, wherein:
one end portion of the second internal electrode has a structure of being recessed into an inner side of the groove at one end portion of the body in the length direction, and the first electrode separation layer is disposed in a space between two adjacent dielectric layers.

5. The capacitor of claim 2, wherein:
the body further comprises a second electrode separation layer disposed between the second external electrode and the first internal electrode.

6. The capacitor of claim 5, wherein:
one end portion of the first internal electrode has a structure of being recessed into an inner side of the groove at the other end portion of the body in the length direction, the second electrode separation layer is disposed in a space between two adjacent dielectric layers.

7. The capacitor of claim 1, further comprising a lower insulation layer disposed between the groove and the body.

8. The capacitor of claim 1, further comprising:
a first external electrode connected to the first internal electrode on an upper surface of the body;
a second external electrode connected to the second internal electrode on the upper surface of the body; and
an insulating layer that is disposed on a portion other than a portion where the first external electrode and the second external electrode are disposed on an outer circumference of the upper surface of the body.

9. The capacitor of claim 1, wherein:
the groove has a structure in which one side in a width direction is open to a side surface direction of the substrate, and one side of the body in the width direction is disposed on the side surface of the substrate.

10. The capacitor of claim 1, wherein:
the substrate includes a longitudinal ridge portion that protrudes upward from a bottom surface of the groove and is disposed to be spaced apart from a width direction side of the groove.

11. The capacitor of claim 1, wherein:
the substrate includes a transverse ridge portion that protrudes upward from a bottom surface of the groove and is disposed to be spaced apart from a length direction side of the groove.

12. The capacitor of claim 1, further comprising:
a first external electrode connected to the first internal electrode on an upper surface of the body; and
a second external electrode connected to the second internal electrode on an upper surface of the body,
wherein a boundary between the body and the substrate in a lower area of the first external electrode and the second external electrode is inclined with respect to the upper surface of the substrate.

13. The capacitor of claim 1, wherein:
the width of the groove is 1 time or more and 44 times or less compared to the depth of the groove, and the length of the groove is 1 time or more and 54 times or less compared to the depth of the groove.

14. The capacitor of claim 1, wherein:
the depth of the groove is 100 um or less.

15. The capacitor of claim 1, wherein:
the first internal electrode and the second internal electrode are disposed only in the groove.

16. A capacitor manufacturing method comprising:
forming a groove that is recessed from an upper surface of a substrate in a direction towards a bottom surface of the substrate;
forming an internal electrode layer and a dielectric layer on the upper surface of the substrate and on the groove;
forming a body on the groove to include an internal electrode formed through the internal electrode layer and the dielectric layer, by removing portions, disposed outside the groove, among the internal electrode layer and the dielectric layer; and
forming an external electrode connected with the internal electrode on the body.

17. The method of claim 16, wherein:
wherein the removing the portions of the internal electrode layer and the dielectric layer is performed through a polishing process.

18. A capacitor comprising:
a substrate including a groove having a depth from an upper surface of the substrate; and
a body comprising a first internal electrode and a second internal electrode stacked disposing a dielectric layer therebetween, and disposed on the groove,
wherein the first internal electrode and the second internal are disposed only in the groove.

19. The capacitor of claim 18, further comprising:
a first external electrode disposed on an upper surface of one end portion of the body and the upper surface of the substrate to connect to the first internal electrode; and
a second external electrode disposed on an upper surface of the other end portion of the body and the upper surface of the substrate to connect to the second internal electrode.

20. The capacitor of claim 19, further comprising:
a first electrode separation layer disposed between the first external electrode and the second internal electrode; and
a second electrode separation layer disposed between the second external electrode and the first internal electrode.
